(19) United States
(12) Patent Application Publication
(10) Pub. No.: US 2008/0097811 A1
(43) Pub. Date: Apr. 24, 2008

(54) Systems and methods for reducing poverty

(76) Inventors: Fritz Kramer, Evergreen, CO (US); Michael S. Roberts, Phnom Penh (KH)

Correspondence Address: TRAN & ASSOCIATES, 6768 MEADOW VISTA CT., SAN JOSE, CA, 95135, US

(21) Appl. No.: 11/588,195

(22) Filed: Oct. 24, 2006

(51) Int. Cl. G05B 19/418

(52) U.S. Cl. 705/8

(57) ABSTRACT

Systems and methods for generating and monitoring a plan to reduce poverty include identifying market opportunities exploitable by one or more smallholders; generating an intervention plan to assist the smallholders; establishing a supply chain to deliver supplies to the smallholders and establishing a linkage with an output market; and monitoring and evaluating the intervention plan.

### COPYRIGHT RIGHTS

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Information management is an overwhelming task faced by people in many professions. In particular, people who must evaluate data in order to make qualification decisions or to plan a course of action must make decisions based on a great deal of data. In many cases, the data must be evaluated according to certain guidelines. While guidelines are followed during the decision making process to the extent possible to avoid missing details that aid in making the decision, subjective judgments must still be made regarding the parameters of the situation due to the large amounts of data that must be processed and the great number of criteria (dictated by the guidelines) involved in many decisions. Further, not all available data is pertinent to the decision, and much time and effort is wasted by not putting aside this irrelevant data early in the decision making process.

Guidelines used in processing such data can be a valuable aid in making a qualification decision or in planning a course of action. For example, in the last decade, clinical practice guidelines have proliferated widely as professional organizations, academic and private institutions, insurers, hospitals, and governments have developed them in the hope that they will facilitate the development of more consistent, effective, and efficient medical practices. Guidelines that are based upon sound scientific evidence, and a trustworthy process for judging the value of alternative practices, can be a valuable aid to decision making by businesses large and small alike.

Good guidelines, however, do not necessarily translate into useable tools. Guidelines have become increasingly complex, and the amount of data processed has grown to overwhelming proportions. For example, instead of using simple checklists to trigger standard medical interventions for all patients of a certain age and gender, health care practitioners must consider a wide range of health risks, the presence of which can mandate changes in the content, timing, and frequency of appropriate medical interventions. To be most effective, decision makers in all fields need practical strategies for applying guidelines in daily practice. They need new tools to facilitate data assessment, documentation of determinations, and individualized implementation of practice guidelines in an objective manner.

Systems have previously been designed which process data in order to qualify or plan a course of action regarding individuals. For example, U.S. Pat. No. 4,622,013 to Cerchio discloses an interactive software training system. This is an early diagnostic expert system which branches to different paths during a training exercise based on inputs from the user.

U.S. Pat. No. 5,005,143 to Altschuler discloses a rule based computer system for selecting from a set of output actions for combinatory situations defined by a plurality of input parameters. The system employs a decision tree structure that is developed by a particular user. Random values of the input parameters are generated and the random values are biased by a function of preceding responses. The steps are repeated until a sufficient number of responses having a predetermined statistical significance are determined for each node of the decision tree. After this point, the user's response to given input parameters can be predicted based on previous user selections as manifested in the node decisions. U.S. Pat. No. 4,733,354 to Potter et al. also discloses a system for automated medical diagnosis using decision tree analysis. U.S. Pat. No. 4,730,259 to Gallant discloses a similar expert system that will follow an approximate course from input to output if a path is not defined for a particular set of inputs.

U.S. Pat. No. 5,208,898 to Funabashi et al. discloses a knowledge processing system employing a method by which primary events for which no determining means is provided are operated upon by knowledge represented as rules referring to the primary events for estimating or predicting the events by use of the same knowledge so as to enable the knowledge to be adapted to an inference. Events as knowledge representing an object are combined with rules as knowledge so as to establish a relation of combination. A grade representing a degree at which an event is satisfied or unsatisfied is obtained depending on a condition part represented in a form of a logical arithmetic expression including an expression of fuzzy logic.

U.S. Pat. No. 4,945,476 to Bodick et al. discloses a software system for editing a knowledge base which is used as a tool in a diagnostic system. The software system includes stored pictorial images that are linked to case record text files.

U.S. Pat. No. 5,023,785 to Adrion et al. discloses a blood analysis expert system. The system accepts data in the form of hematologic parametric numerics obtained from a patient's blood assay. The system executes instructions stored in a memory and on the basis of the parametric numerics prints out diagnostic and hematologic messages applicable to the patient.

U.S. Pat. No. 4,839,822 to Dormond et al. discloses a computer system which generates suggested courses of treatment for persons who have been physically injured. A user is presented with a series of questions and graphical illustrations of physical trauma, which the system uses to elicit pointed responses from the user. These responses are used, along with the contents of a stored knowledge base, by an inference engine to determine and generate a suggested treatment for the injury.

U.S. Pat. No. 5,255,187 to Sorensen discloses a computer aided process for diagnosing a patient's disease or illness. A doctor observes the patient's symptoms and extracts the patient's personal, family, and medical histories. These data are entered into a computer. A program resident in the computer manipulates the data and displays determinations of which disease or illness the patient has. Once the illness is identified, suggested treatment for the illness is displayed for the doctor. These systems are useful in processing large amounts of information in order to determine a reliable result or other output. Some of these systems provide answers based on data provided in response to questions. However, guidelines which give rise to the questions to be asked may not always be so simple to administer. Thus, while these existing systems provide general answers based on guidelines, they do not allow a user to create an interactive program based on guidelines that is tailored to particular situations. A more useful system would extract relevant data in an interactive manner from comprehensive guidelines, and process this data to provide another interactive process more suited to individual circumstances. This second process or program that is created could be used to extract further data in a more relevant fashion in order to formulate a qualification decision or a course of action.

U.S. Pat. No. 5,347,614 discloses a knowledge processing system structuring method and tool. By preparing a general-purpose search program on the basis of information inputted by the user, an inference program for a given problem to be solved and a given object domain is created. The general-purpose search program is constituted by a plurality of search elementary functions. A guide message is displayed on a display unit in accordance with classified information of a problem solving strategy. Program creating knowledges are obtained from the information inputted by the user in response to the guide message. By employing the program creating knowledges, a general-purpose program is created with the aid of a correspondence table containing correspondences between search elementary functions having search primitive functions built therein and search fundamental functions. The correspondence table may comprise a first correspondence table containing correspondences established between the search primitive functions and the search fundamental functions and a second correspondence table containing correspondences between search fundamental functions and the search elementary functions.

U.S. Pat. No. 5,574,828 discloses a software program used to write other software application programs for the implementation of guideline applications for use in situations where a qualification decision or next course of action determination must be made. The system uses questions with limited choice answers. Data provided in answer to the questions causes a second program application to be automatically generated based on the answers. The second application then elicits responses in an interactive manner. Qualification decisions and courses of action are suggested as an output of the second application. Means are provided for evaluating the reliability of the suggestions based on consistency of answers and fatigue of the user. Means are also provided for editing either application program.

In a separate trend, “The world has become more economically polarized both between countries and within countries,” said James Gustave Speth, administrator of the U.N. Development Programme (UNDP). “If present trends continue, economic disparities between industrial and development nations will move from inequitable to inhuman.” Speth made the remarks July 16 upon releasing the 1996 Human Development Report, the seventh annual edition. The report noted that developing countries, with 80 percent of the world's population, account for only about 20 percent of world output. To reduce inequality while promoting growth, the report suggests that national authorities need to give more attention to human development, poverty reduction, and employment policies, especially for women; expand access to land and credit; boost investment in and access to education and health; and encourage development of that informal sector of the economy that often does business on the street and in homes.

More than 1.2 billion people live in “extreme consumption poverty.”. Seventy-five percent of those people live in rural areas, have small plots of land and depend on agriculture for their livelihood. Solutions to rural poverty need to focus on these rural poor farmers.

### SUMMARY

In one aspect, systems and methods for generating and monitoring a plan to reduce poverty include identifying market opportunities exploitable by one or more smallholders; generating an intervention plan to assist the smallholders; establishing a supply chain to deliver supplies to the smallholders and establishing a linkage with an output market; and monitoring and evaluating the intervention plan.

In another aspect, an expert system to reduce poverty is disclosed. The expert system includes code to identify market opportunities that can be exploited by smallholders; develop solutions that the smallholders can use to generate income; establish supply chains to deliver technologies to the smallholders at affordable prices; and establish linkages with output markets for the smallholders

Implementations of the above aspects may include one or more of the following. The system can determine irrigation improvements such as drip irrigation in areas where wells no longer produce enough water to support conventional surface irrigation. The system can recommend drip and micro-sprinkler systems and low-cost water storage tanks linked to micro-irrigation of high-value crops. The system can determine market demands for crops that smallholders can produce and sell for profit. The system can recommend opportunistic solutions to reduce poverty. The system can identify untapped, underutilized, or poorly utilized resources and recommend an effective utilization of resources such as credit, critical technology, knowledge of improved agriculture methods, among others. The system can optimize its recommendations based on Smallholder Poverty Alleviation, Wealth Creation, Market Sustainability, Project Cost Effectiveness, Model Validation, Gender/Sociocultural Impact, and Environmental Impact. The system can identify supply chains for micro-irrigation and agricultural inputs, together with technical support, quality control, and training of dealers and sub-dealers to provide effective services to farmers. The system can create demand through social mobilization and through the provision of technical assistance to smallholders. The market development can be done through an establishment of collection centers for smallholder produce and through workshops to link traders to the collection centers. The system can link farmers to micro-credit sources. The system also performs a gender analysis including a cultural and societal study. This can be done by analyzing roles that women and men play; resources, activities and benefits women and men have access to and control over; daily workloads of women and men; and practical and strategic needs, interests and priorities of women and men. The intervention plan can be based on a market strategy, a water strategy, a gender strategy, and a partnership strategy. The monitoring and evaluating of the plan can be done by monitoring various poverty, environment, and gender criteria.

Advantages of the system may include one or more of the following. The system enables an efficient implementation of practical, innovative strategies for the co-existence of social justice and economic development. The system is attuned to the real need for the resources that keep a region politically and socially healthy. The system enables market driven forces such as demand-driven, decentralized, private-sector led efforts for fighting poverty. Innovation and entrepreneurship are enhanced for sustainability. The rural poor are customers, producers, and entrepreneurs, not charity recipients. The system allows smallholders—those who have lifted themselves out of abject poverty—to participate more fully in markets by purchasing more inputs, making effective use of technical knowledge and market information, and developing stable linkages to output markets. The system supports further development efforts by learning from the people needing help. The system helps create market conditions that enable the rural poor to become successful market participants. Concepts and practices usually associated with private business are applied to the problem of poverty. This is done by identifying market opportunities that can be exploited by poor people; developing technologies that the poor can use to generate income; establishing supply chains to deliver technologies to the poor at affordable prices; conducting promotional campaigns to convince smallholders to invest in income-generating technologies; establishing linkages with output markets, and ensure that everyone in the market network, especially the smallholder, receives a fair profit. The system applies markets to provide a powerful positive impact on the lives of the rural poor and enables smallholders—those who have lifted themselves out of abject poverty—to participate more fully in markets by purchasing more inputs, making effective use of technical knowledge and market information, and developing stable linkages to output markets.

### BRIEF DESCRIPTION OF THE DRAWINGS

FIG. 1A shows one embodiment of a Poverty Reduction through Irrigation and Smallholder Markets (PRISM) system.

FIG. 1B illustrates one embodiment an expert system that supports the PRISM system.

FIG. 2A shows an exemplary flowchart supported by the PRISM system.

FIG. 2B shows an exemplary planning process with four phases.

FIG. 3 shows an exemplary situational analysis.

FIG. 4 shows an exemplary sub-sector analysis.

FIG. 5A illustrates an exemplary Sub-sector Map of the Vegetable Sub-sector at the Pokhara Market in Nepal, and FIG. 5B shows an exemplary Sub-sector Map of the Porker Sub-sector, Dakrong District, Quang Tri Province, Vietnam.

FIG. 6A shows an exemplary integrated system of private-sector enterprises that include input suppliers, small-farm families, and output markets, while FIG. 6B shows exemplary PRISM Interventions in Nepal at the Input, On-Farm and Output Levels.

FIG. 7 shows an exemplary integrated system of private-sector enterprises that include input suppliers, small-farm families, and output markets.

### DESCRIPTION

Referring now to the drawings in greater detail, there is illustrated therein structure diagrams for a poverty reduction system and logic flow diagrams for the processes a computer system will utilize to complete various analyses and recommendations thereto. It will be understood that the program is run on a computer that is capable of communication with consumers via a network, as will be more readily understood from a study of the diagrams. The following definitions are provided to aid in construing the specification and claims of the present application:

Expert System: Expert systems enable computers to make decisions for solving complex nonnumeric problems. Whereas conventional computer programs principally perform functions such as data manipulation, calculations, and data storage and retrieval, expert systems use a knowledge base and an inference engine to make decisions.

Knowledge Base: a knowledge base is a collection of rules that represent the human expertise of a particular knowledge domain. Rules are typically constructed in an IF-THEN-ELSE format, e.g., IF Project is low risk to farmer (market risk, technology risk, production risk) AND short payback period AND high potential income impact, THEN Initiate Project Implementation and Flag Project for Review. The knowledge base is typically stored in a storage medium of a computer.

Inference Engine: an inference engine is a software deal structuring that runs on a computer. An expert system operates by running a knowledge base through an inference engine and applying all of the rules to the input data for a given problem.

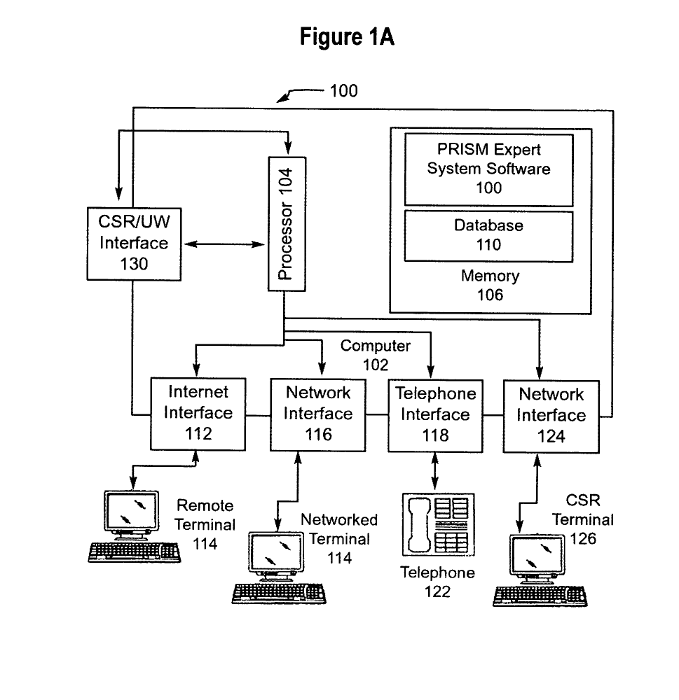

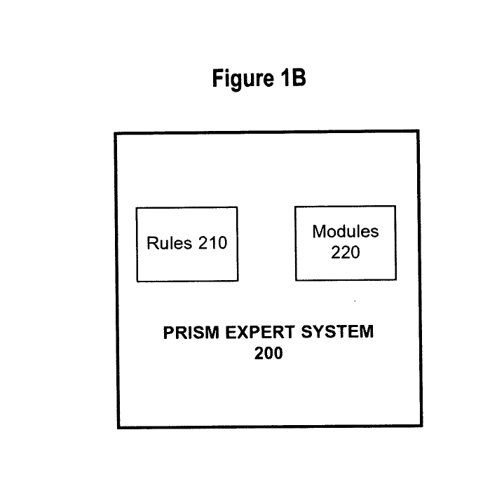

Referring now to FIG. 1A, one embodiment directed to an automated process for poverty reduction is illustrated. As shown in FIG. 1A, the Poverty Reduction through Irrigation and Smallholder Markets (PRISM) system 100 includes a computer 102, which may be a mainframe computer, a minicomputer, a microcomputer, or other general purpose computing machine. The computer comprises at least one processor 104 and a memory 106, which may be temporary memory, such as random access memory, permanent storage, such as a hard drive, or a combination of temporary memory and permanent storage. Expert System Software 100 [hereinafter “ESS”] is stored in memory. Alternatively, ESS 100 may be stored on a removable computer readable medium, such as a CD-ROM (not shown).

The memory is also used to store expert system rules as well as data regarding each project or deal structuring. This information can be stored in a database 110 within the memory 106. The database 110 is preferably a database managed by a database management system, such as IBM database or Oracle database, among others. The computer 102 also has several interchanges, such as interfaces, for communicating with other entities. These interfaces include an internet interface 112 for communicating with customers 114 accessing the system 100. Also included is a network interface 116 allowing networked computers to access the system 100. The network computers 114 can be located in a facility operated in conjunction with system 100, such that customers can access the system without having Internet access. The system also has a telephone interface 128, such that customers can dial into the system to access system 100. The system also has a customer service representative (CSR) interface 126 so that a consultant can access the system and utilize the automated processing of the system 100. Further, the system includes a remote interface, which allows a CSR at a remote location to access the PRISM system. The system further includes a non-interface, which allows a CSR to operate the PRISM system in stand-alone mode. In addition, the illustrated system 100 may include at least one third party interface, for third parties such as credit bureaus, third party manufacturers/resellers and third party micro loan offerors. The system 100 also includes an interface that invokes a CSR or loan underwriter interface 130 (hereinbelow called the CSR/UW interface) to become involved in a microloan deal structuring when invoked by a customer. There may or may not be limitations placed on the invocation of the CSR/UW interface, such as time limitations or multiplicity limitations, and the placement of such limitations on invocation will be understood to those skilled in the art.

The PRISM system is used to develop an understanding of the unique situation of the rural poor and to create sustainable solutions to rural poverty. The PRISM system supports the creation sustainable opportunities through market-oriented interventions by: (1) creating networks of small enterprises to provide agricultural supplies needed by poor farmers; (2) working with farmers to improve small-farm productivity; and (3) linking small-farm families to markets for effective and sustainable poverty reduction. Using the PRISM model, millions of small farm households can be integrated into markets and create sustainable businesses to reduce rural poverty worldwide.

In one embodiment, the PRISM system 100 is a knowledge-based expert system that uses human knowledge to solve problems that normally would require human intelligence. The expert system represents the expertise knowledge as data or rules within the computer. These rules and data can be called upon when needed to solve problems. Knowledge-based systems collect human know-how into a knowledge-base which is used to reason through a problem, using the knowledge that is appropriate. A different problem, within the domain of the knowledge-base, can be solved using the same program without reprogramming. The ability of the system to explain the reasoning process through back-traces and to handle levels of confidence and uncertainty provides an additional feature that conventional programming don't handle.

FIG. 1B illustrates one embodiment of the ESS 200 of the present invention. The ESS 200, resident on the system 100 includes rules 210, and modules 220. One example of rules 210 is an IF THEN rule such as: IF Project is Low risk to farmer (market risk, technology risk, production risk) AND Short payback period AND High potential income impact, THEN Initiate Project Implementation and Flag Project for Review. Modules 220 can include data collection modules, database management modules, communication modules, CSR modules, and financial reporting modules, among others.

In one implementation, the ESS 200 is developed with specialized software tools called shells. These shells come equipped with an inference mechanism (backward chaining, forward chaining, or both), and require knowledge to be entered according to a specified format (all of which might lead some to categorize OPS5 as a shell). They typically come with a number of other features, such as tools for writing hypertext, for constructing friendly user interfaces, for manipulating lists, strings, and objects, and for interfacing with external programs and databases. These shells qualify as languages, although certainly with a narrower range of application than most programming languages. The shell can be WindExS (Windows Expert System), a Windows-based forward chaining expert system whose modular architecture allows the user to substitute new modules as required to enhance the capabilities of the system. WindExS has Natural Language Rule Processor, Inference Engine, File Manager, User Interface, Message Manager and Knowledge Base modules and supports forward chaining, and graphical knowledge base representation. In another example, the shell can be the RT-Expert system that lets C programmers integrate expert systems rules into C or C++ applications through a rule-compiler that compiles rules into C code and a library containing the rule execution engine.

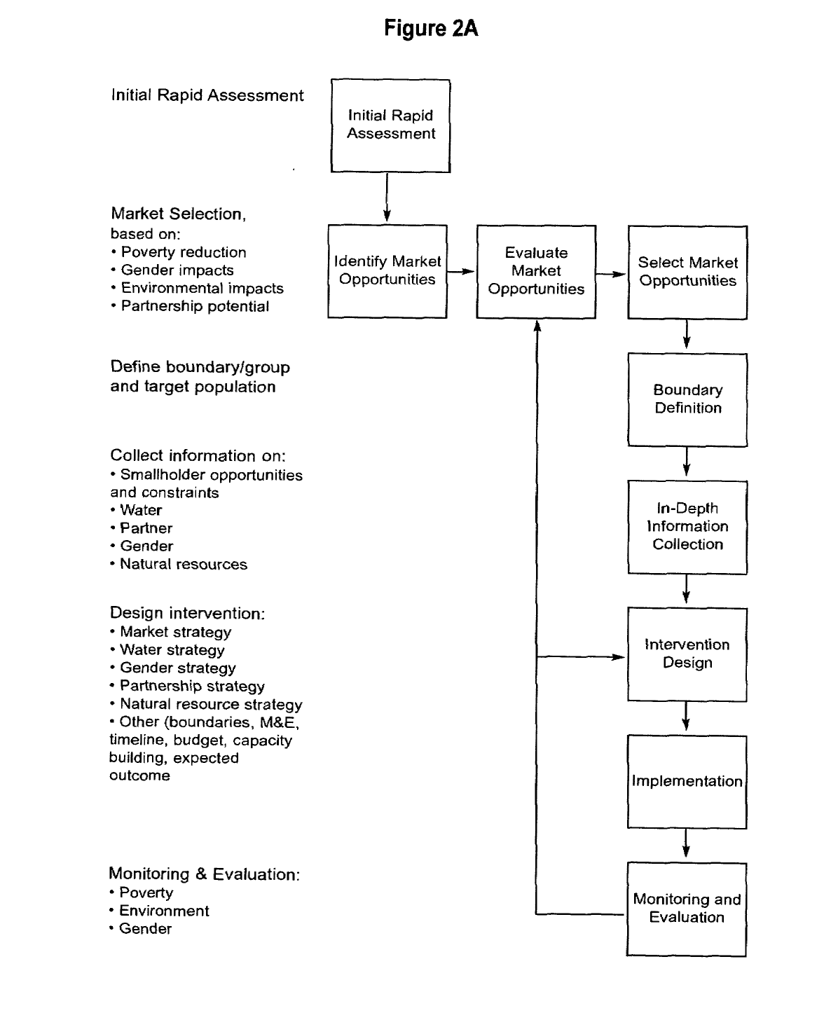

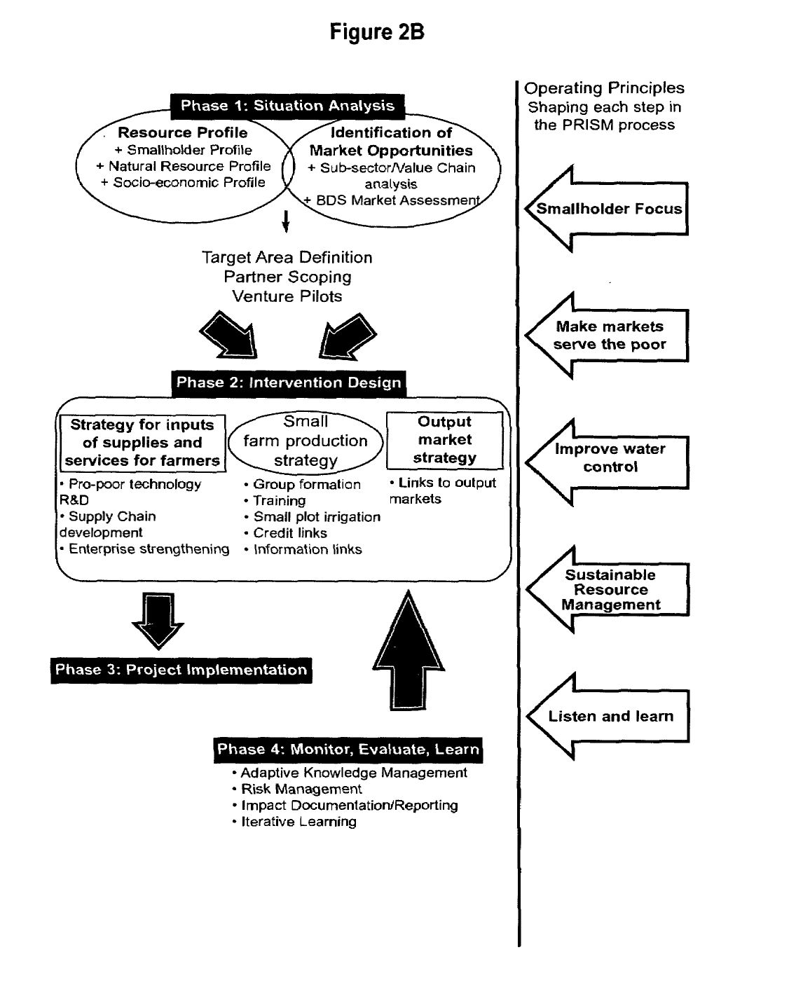

FIG. 2A shows an exemplary flowchart supported by the PRISM system. In this process, an initial rapid situational assessment is done. Next, market selection is determined based on poverty reduction goals, gender impacts, environmental impacts, and partnership potential. The system then defines a boundary/group and target population. The system collects data on smallholder opportunities and constraints, water, potential partnerships, and available natural resources. Next, the system designs an intervention plan that includes market strategy, water strategy, gender strategy, partnership strategy, natural resource strategy, and other variables such as timeline, budget, capacity, expected outcome, among others. The system then periodically monitors and evaluates the results based on the plan's effect on poverty, the environment, and improvements in gender equality, among others.

The PRISM system focuses on the unique advantages of rural farmers. PRISM uses these advantages to increase smallholder income. To achieve positive impact on a large scale, PRISM also seeks to change the larger context in which rural farmers live by working with local communities to develop strategies for effective natural resource management, gender equity and policy change. This combination of increasing the income of small-farm families and changing the context in which smallholder families live supports people to lift people from poverty. Smallholders' needs, opportunities and constraints differ in every context. For this reason, the PRISM ESS 200 is flexible in designing, implementing and revising an intervention. Each intervention will differ according to smallholder needs, local priorities and opportunities. Planning a PRISM intervention involves progressively defining, revising, and focusing the intervention as more knowledge is gained and different ideas developed. This planning process is done in four phases which are shown in FIG. 2B as follows:

Phase 1: Situation Analysis In the first phase, the PRISM system examines a geographic area to:

Understand general patterns and trends;

Collect background information;

Understand the smallholder situation;

Develop an understanding of smallholder constraints and opportunities.

Through this scoping process, potential smallholder market opportunities are evaluated and possibilities for market interventions that enhance the unique advantages of the smallholder farmer are identified.

Phase 2: Intervention Design. In the second phase, the PRISM system designs an intervention that builds on the advantages of smallholder farmers and addresses constraints that prevent smallholders from participating in market opportunities. A Project Implementation Plan (PIP) can be developed to detail how small-farm families will access identified market opportunities. The PIP integrates strategies to manage the value chain in accordance with PRISM's social and environmental principles. The PIP details intervention strategies and specifies activities, timeline, baseline measurements, anticipated impact, financing, monitoring, evaluation and other important aspects of the intervention.

Phase 3: Project Implementation. In this phase, the project is implemented, with regular monitoring, reflection and feedback regarding the project's effectiveness and efficiency.

Phase 4: Evaluate and Learn. In this phase, the program is evaluated to assess whether the goals and objectives are being met. The intervention is adapted, as needed, based on the learning generated from the evaluation.

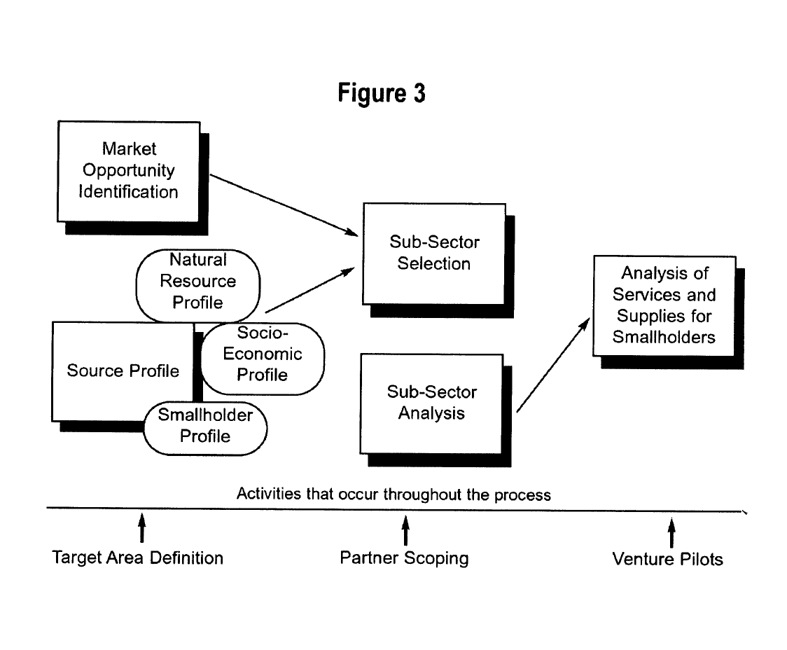

In Phase I, the system executes a process for identifying market opportunities for increasing smallholder income. As shown in FIG. 3, the PRISM Situation Analysis provides a more detailed illustration of the Situation Analysis process. In general, good market opportunities for smallholders are agricultural products for which smallholders have, or can develop, a comparative advantage. These advantages may arise from:
Lower production costs due to low opportunity cost of land and labor in impoverished areas;
Family labor (and even labor hired to work in a small area) is more easily recruited, screened, supervised and motivated than hired workforces on larger farms;
As resident owner-managers, smallholders are in close contact with their production environment and are able to provide the extra care needed to cultivate high-quality produce;
For local markets, smallholders are more familiar with local preferences and can supply fresher produce with lower transport costs;
Unique climate or land characteristics may provide opportunities for growing unique crops or growing common crops in the off-season. Identifying products for which smallholders have a comparative advantage involves matching local conditions (agro-climatic, geographic, cultural, etc.) with potential crops; and evaluating potential growth in various markets (local, regional, and export). This process may be approached in either of two directions: Start with smallholders and ask “What product can you produce for the market?” or Start with a promising market opportunity and ask “Who can produce this product for the market?” For example, in Zambia, the system identified paprika as ideal for smallholder-based production. Paprika requires careful attention, so smallholders in Zambia are better suited to care for this crop than large-scale farms. Looking for crops for which smallholders have a comparative advantage requires crops that can be adapted to small plots. Types of market opportunities to look for include: Higher sale price from off-season production; Import substitution; Export opportunities; Product differentiation; Emerging markets.

One exemplary pseudo-code for identifying smallholder market opportunities is as follows:
Look for promising market opportunities and explore many different aspects.
Select opportunities that provide significant income or meet the food needs of smallholders. To provide income, smallholders must be able to get the harvested products to markets that provide high returns.
Focusing on crops that are currently being grown can be cost-effective, minimize risk and utilize existing smallholder knowledge and skills.

For each project, the process optimizes the objectives in the table below, as quantified by the indicators:

| Objective | Indicators |
|---|---|
| Smallholder Poverty | Average smallholder annual income |
| Alleviation through | Average per capita income |
| Wealth Creation (number | Smallholder net income change (per capita, per household) |
| and percent change in | |
| income) | |
| Access to Smallholder | Smallholders that purchase products and services, including |
| Markets (number and | technology, agricultural inputs, micro-credit) |
| percent change) | |
| Development of | BDS providers, by product and/or service |
| smallholder markets | Average BDS provider income and profit margin by product |
| (number and percent | and/or service |
| change) | Number of people trained by product and/or service type |
| | Number of promotional activities by product and/or service |
| | Use of credit by BDS providers by product and/or service |
| Assessment of Project | Total project cost |
| Cost Effectiveness (N) | Number of smallholders served |
| | Total net income of smallholders served |
| | Number of BDS enterprises created |
| | Total net income of BDS enterprises created |
| | Total project cost per smallholders served |
| | Smallholder return on program investment |
| | Total project cost per BDS enterprise created |
| | BDS enterprise return on program investment |
| Poverty Impact | Reinvestment of farm income in health, education, nutrition, |
| | agriculture, productive investments (shelter, clothing, |
| | livestock, land), social investments (weddings, funerals, |
| | naming ceremonies, etc). |
| | Smallholder percent change in food security |
| | Smallholder percent change in nutritional status |
| | Smallholder percent change in educational status |
| | Smallholder percent change in health status |
| | Smallholder percent change in housing status |
| | Smallholder percent change in potable water supply and |
| | sanitation system |
| | Smallholder percent change in asset base |
| | Smallholder percent change in investment in productive assets |
| | Smallholder percent change in investment in social assets |

The process prompts a user such as a smallholder consultant to:
Focus on sub-sectors with low start-up costs and sub-sectors that promise a rapid return on investment. This helps ensure that smallholders can invest and maintain and increase investments in the future.
Focus on sub-sectors with large and growing demand.
Focus on non-perishable crops.
Consider ways to minimize smallholder risk (e.g. crop diversification and ensuring that smallholder household food needs are met helps to minimize smallholder risk). See below for additional discussion on risks faced by smallholders and reducing those risks.
Focus on high-value crops for which smallholders have or can develop a comparative advantage (e.g. crops that require a high degree of labor intensity or attention to detail and/or crops that benefit from intercropping).
Focus on crops for which smallholders can be organized as a group and assisted to compete effectively with industry.
Examine sub-sectors where gains can be made through improving land and water productivity rather than labor productivity.
Examine areas where processing facilities are available.
Focus on sub-sectors that sustain the natural resource base.
Understand the value chain and identify how to integrate smallholders into the value chain.
Examine off-season production potential through irrigation to assess whether this would generate additional income.
Examine possibilities for import substitution.
Examine possibilities for differentiation of smallholder products (through branding, etc.)
Focus on crops that rely on the unique land or produce characteristics (regional branding, agro-ecological advantage)
Examine emerging markets.
Think about the value chain and sustainability from the beginning, during the process of identification, assessment and selection of opportunities.
Formulate projects around expressions of interest from private companies, which can provide valuable assistance (e.g. free market assessments, in-country technical expertise, and contracting assistance). Donors frequently ask the question: “Where is the market for this smallholder product?” So, market identification at the beginning of the process adds value to proposals to donors.

The system also identifies characteristics of attractive sub-sectors for smallholder market development In selecting a sub-sector, it is useful to determine which criteria, or characteristics, of the sub-sector are most important. The following characteristics of subsectors that often benefit smallholders are analyzed:
Large number of smallholders served
Low risk to farmer (market risk, technology risk, production risk)
Short payback period
High potential income impact
Expanding market
Full-spectrum markets available (low-end to high-end, local to export, season to season)
Key “logjams” in the value chain are easily identified and resolved at low cost
Low entry cost for smallholders
Low requirement for new knowledge by smallholders
More intensive crop management adds extra value (capitalizing on smallholders' labour advantage)
Involvement of women in production and marketing
Positive or neutral environmental impact
Synergy with other intervention programs
High donor interest
   In one embodiment, the system obtains the following input:
Poverty: Who are the poor? Where are the poor? When are they poor (e.g. chronic poverty or seasonal poverty)? Approximately how many are poor? What are the population patterns (density, migration, urbanization)? Is there a need to help the poor meet nutritional needs or raise income or both? What are some ways to identify and reach those poor?
Natural resources: What are the current land-use patterns (soil conditions, cropping systems)? How are these changing? Are there important macro-level natural resource issues that may impact land and/or water use (large-scale deforestation, conflicts over natural resources, desertification)? Are there laws/policies/customs at the regional, national, or international levels that impact use or control over natural resources?
Markets: Are there laws or policies at the regional, national, or international level that impact market access? Are there current/potential businesses or business development services that could impact a large number of smallholders? Are there supply systems to support new crops? What are the demand patterns and trends in demand? How do government policies impact potential sub-sectors?
Socio-cultural: Are there ethnic groups with differing roles in potential sub-sectors? What laws/policies/customs impact gender use or control over resources, access to the market or role in meeting household nutritional and other needs? Does this role and status vary in different regions? Are these laws/policies/customs changing? The PRISM Toolkit provides Tools for Gender Analysis.
Partnership: Are there potential partners at the national level, such as government agencies, private sector, research institutions, donors, or NGOs? The PRISM Toolkit provides Tools for Partnership Development.
   Information is gathered through literature reviews, collecting and analyzing secondary data from government agencies, research institutes, business associations, local universities, donor agencies, other knowledgeable sources and field visits.
   This high-level information provides an understanding of the patterns and trends affecting potential projects. It also helps identify regions and markets where a PRISM intervention would be successful.

The PRISM system performs a detailed examination of the smallholder's situation as follows:
Water: Usually, water is the single most important factor limiting smallholders from earning more income. Other inputs generally do not limit smallholders. For example, labor is usually widely available and not expensive. Seed, fertilizer, and pesticides are required in small quantities. Water, however, is heavy and is required in large quantities. Natural rainfall is often variable. Reliable crops require a reliable water supply and efficient use of that water supply. See section below for information and data collection recommendations regarding water.
Crops: What crops are traditionally grown and in which regions? Which of these crops are high-value? Can these crops be stored? Can these crops be exported? Which crops can generate the most income for poor farmers? Are there gender or environmental implications of the crop choice?
Land: What land ownership and land use patterns exist in the region(s)? Do small farm families own their land? Do they lease the land? Do they share the land with other smallholders? Are their rights to use the land permanent? Are they willing to invest in equipment needed to grow crops on the land?
Soil and Inputs: What are the soil types for the given region(s)? What are the pest issues for a given region and crop? What are the pesticide and fertilizer requirements? Does the smallholder gather their own seeds or purchase them? Can these inputs be easily obtained at reasonable prices?
Labor: What are the labor requirements for the crops? How do these requirements change during the growing season? What are the gender aspects of labor? What are the likely impacts of intervention on the labor equation?
Credit: What (if any) are the potential sources of credit? Are there other credit systems in the region/country that might be made available? Are there ways of organizing groups of smallholders to obtain credit?
Markets: What are the potential local, regional, national, and international markets? How ‘open’ are the markets—can smallholders access the markets and receive a fair price? What is the price of the crop at the market? Does the price depend on quality? How do the prices vary in different seasons?
Transport: What is required to bring produce to the market? What is the transportation cost? How much time is needed? Will the roads damage sensitive produce? Do smallholders transport the produce themselves, organize to transport it, or sell to middlemen at the farm gate?
Organizations: What organizations can help the smallholder obtain knowledge, credit, inputs, access to water, marketing, and transport?

### One implementation collects the following data to assess potential opportunities for developing PRISM.

Data Collected By the System

Number of smallholder farmers involved (current and potential), disaggregated by gender
Capital, credit, and technology available or potentially available to smallholders
Potential to effectively and efficiently organize smallholders
Identification of high-value crops in which smallholders have an advantage
Capital investment costs for smallholders and return on smallholder investment (amount of return and
timeframe of return)
Number of business development service providers (current and potential), disaggregated by gender
Increased potential for income generation of MSEs (smallholders) and BDS providers (disaggregated by
gender)
Seasonality of identified crop - assessment of price fluctuation by season
Cost advantages for smallholder involvement
Smallholder able to meet household needs
Diversification of smallholder crops
Smallholders continue to grow current crops
See “smallholder risk assessment”, below, for information on smallholder risks
Potential agro-industrial competitors in sub-sector
How many farmers live in that area?
What are the primary crops raised in that area?
What is the current use of high yielding seeds by small farmers?
What is the role of animal-traction in agricultural production? What times of the year are draft animals
used? What is the cost of fodder (if used) per day?
What is the average daily wage for rural labor? Are there fluctuating demands on rural labor?
Is there a sizable agricultural market within a selling distance for the small farmer?
Different roles, attitudes, and interests of women and men in agriculture and the market economy
Social relations between women and men pertaining to their access to, and control over resources, benefits
and decision-making processes
Different perspectives of women and men toward potential interventions
Current and potential number of women who are self-employed, own businesses or work as employees of
other firms in the sub-sector
Differential perspectives, roles, practical needs, and strategic interests of women and men in the sub-
sector, household, economy, and project area.
Social relations between women and men pertaining to their access to, and control over resources, benefits
and decision-making processes.
Intervention would increases women's access to and control over productive assets/processing/marketing
Current employment statistics, disaggregated by gender
Estimates of employment projects, disaggregated by gender
Potential for enterprises (large and small) to create new employment opportunities as the sub-sector
develops or expands
Benefits to smallholders outweigh the costs of facilitating support services. This includes quantifiable
benefits (net financial benefits compared to program costs) and non-quantifiable benefits (e.g. social
benefits, policy benefits)
See section below for more details.
Land availability
Land use patterns (including land clearing and land alteration practices)
Access to land with agricultural potential
Soil types, quality and fertility
Average farmer plot size and number of plots
Percentage of irrigable land
Current soil management practices and sources of degradation
Currently grown crops
Agricultural imports, and imports related to agricultural production
Land tenure rights (ownership, tenancy, landless)
Number of high value crops possible without negative environmental impact
Number of high value crops possible but not grown
Number of (all) crops currently grown in the area
Percentage of farmers using drip irrigation
Percentage of farmers using treadle pumps
Percentage of farmers doing bucket farming
Current farming techniques (e.g. pest management, crop diversification, use of inputs)
Projected impact on land, water and soils of current agricultural practices
Average size of smallholder farms
Plot sizes for the farmers?
How many plots of land does the average farmer own?
What is the percentage of farmers per plot size?
Percentage of households with livelihoods in agriculture
Potential for technologies or management systems that increase the productivity/earnings of smallholders
or enterprises in the sub-sector
Potential environmental impacts (direct and indirect impacts at the input, on-farm and output levels)
Access to markets that currently or potentially serve large markets (e.g. national, regional or export
markets)
Information on location, size, and potential for growth
Market prices for select vegetables, grains, cash crops
Opinions and data from key informants on market trends and sub-sector competitiveness
Market analysis to understand consumer behavior and preferences (e.g. price, packaging, quality)
Information from existing statistics/studies
Examples of businesses that have problems meeting demand
Current or past initiatives (even failed ones) by small farmers, businesses, organizations
Comparisons within the region (based on opinions from key informants of market information)
Number of business development service providers (current and potential), disaggregated by gender
Seasonality - assessment of price fluctuation by season
Gender roles
Number of markets in each area
Market players
Market institutions
Trends in demand patterns
Miles/kilometers of paved roads and road conditions
Percentage/total population linked to markets by surfaced roads
Average time/distance from household farms to markets
Average distance from farms to paved roads
Transport facilities
Average cost for farmers to transport crops (50 kg) to market
Availability/access to refrigeration and/or storage facilities
Percentage of environmentally possible high value crops currently sold in the area markets
Number of wholesale/retail points of sale for technology and inputs
Size of the manufacturing base capable of producing irrigation components that is linked to a market
Number of manufacturers capable of producing irrigation equipment that have plants located in the area
marketshed
Number of distributors of manufactured goods in the marketshed
Size of the agricultural input production base linked to the market
Percentage of the market devoted to agriculture (number of sellers, number of buyers, percentage of sales
volume)
Availability of credit and/or subsidies
Potential for enterprises to add value to raw materials and gain higher earnings
Market demand for value-added products
Standards
Packaging
Storage
Description of the different kind of transactions that place among domestic market actors in the sub-sector
General description of the volume and number of these transactions between a given number of firms
The number and volume of transactions that take place among domestic market actors in the sub-sector
Potential forward/backward linkages between large and small enterprises
Large buyers overlook micro-, small-, and medium scale enterprises as a source of supply or are unable to
organize them to meet their demands
Potential for technologies or management systems that increase the productivity/earnings of enterprises in
the sub-sector
Average household income (percentage of income from farm, percentage of income from non-farm
sources).
Information on differences in poverty within communities and within households.
Ethnic/caste/religious and gender analysis of poverty
Ethnic/caste/religious composition and attitudes towards market-based interventions
Human labor potential available for agriculture (including migration rate, disease rates, rates of child-
headed households, etc.)
Total population of the area and population density
Average daily wage for rural labor, demand for rural labor and labor capacity
Household family size (average range)
Government policies that affect small farmers and small-scale irrigation, including:
land use, land access and land tenure policies
water use and access policies
marketing of appropriate technologies
agricultural commodity pricing
subsidies
property rights
rule of law
export
transportation
marketing
effective institutions
Legal differences between women and men in the agricultural sector (e.g. land ownership and tenure
rights, taxation)
National, regional and local political systems and informal decision-making structures and processes
Legal aspects of registering and working as an NGO.
Government labor laws and documents required to work in country.
Donor priorities and policies that impact on project area selection
National and local security history and trends, including travel restrictions and/or security concerns
Which donors (bilateral, multi-lateral) are active in the area and what are their activities and attitudes?
What NGOs/CBOs are active in the area, what are their activities, what is the potential for collaboration?
Government extension and agricultural university organizations that conduct relevant research,
demonstration, educational programs, and promotional projects
Educational level of national staff
Banking system, currency regulations (e.g. possibility to open hard currency account), currency exchange
rate
Availability and cost of housing and office space
Road conditions
Cost and availability of vehicles and fuel
Quality of communications networks in the region

The system provides tools to better understand and address the risks faced by smallholders such as:

1. Market risk

2. Technology risk

3. Production risk

In relation to these three types of risk, smallholders have experience managing production risks. It is more challenging for smallholders to manage market risks and technology risks. Therefore, it is important for an intervention to reduce market and technology risks. The expert system provides strategies help to reduce smallholder risks, involving working with proven markets, proven technologies, solid technical skills, and continuous knowledge flow, as described below:
a. Working with a proven market means ensuring that there is market demand for the smallholder product. For example, vegetables are often a good proven market, because most people eat vegetables. However, new or exotic vegetables may not be a proven market because consumers may not buy a new and different type of vegetable.
b. Ensure that smallholders have a long-term cost advantage compared to competitors. Even for a proven market, smallholders may not make money if there is no cost advantage over larger farms.
c. Smallholder production for a full-spectrum market may help to reduce risk. A full-spectrum market includes both less expensive products (e.g. vegetables for the local market) as well as more expensive products (e.g. vegetables for supermarkets and export markets). If smallholders produce only for the export market, they face higher risks. Production for a full-spectrum market provides flexibility and potential for differentiation.
d. It is important to have good knowledge about the selected crop in order to provide good technical support to smallholders. For example, risk of failure can be reduced with good market intelligence, obtained from industry experts.
e. Use proven technology to reduce risks.
f. Use information from local entrepreneurs regarding successful and failed ventures. Entrepreneurs are risk takers and therefore can provide much useful information about risks.
g. Connect smallholders with outside sources of expert knowledge.
h. Establish demonstration plots and work at first with innovators who are willing to take risks to demonstrate to farmers who are more risk-averse.

In one implementation, crop budgeting tools can be used to understand better a smallholders' net return to land, water and labor. Crop budgets allow planners to estimate the amount of income smallholders will earn in different circumstances. The crop budgets below allow planners to compare yields, inputs required and expected income for four different types of farmers: relatively inexperienced smallholder farmers; very experienced smallholder farmers; experienced smallholder farmers using supplemental irrigation; and experienced smallholder farmers using winter irrigation.

The expert system then identifies opportunities for smallholders by analyzing constraints at each market level and in each constraint category. To focus on the promising areas of intervention, constraints are prioritized to identify “key logs in the logjam” that can benefit large numbers of smallholders. Such leverage points may be found by identifying nodes in the value chain where a small number of firms act as intermediaries for a large numbers of smallholders or by taking advantage of geographic clustering of similar enterprises or production systems or by identifying policy levers that will remove constraints for many market actors at once.

In one embodiment, the system analyzes the following factor:
Sources of leverage: large firm intermediaries, geographic clustering, and policy levers
How many smallholders will benefit? By how much? What is the least costly means of addressing their needs?
Will the envisaged intervention be cost-effective? Will it generate more benefits than costs?

Tools are provided to Compare, Rank and Select Promising Opportunities. These methods include:
Define and refine issues, priorities and questions. Evaluate opportunities through a process of assessment and discussion.
Map areas that satisfy selected criteria. Overlay maps to see where all selected criteria overlap.
Compare and rank areas by determining the relative importance of each selected criterion and then determining how well each area satisfies that factor. Two methods to accomplish this are described below: “Attractiveness Matrix” and “Weighted Ranking Methodology”. The Attractiveness Matrix compares options when there are only two important selection criteria. Where there are more than two selection criteria, the Weighted Ranking method should be used.

Attractiveness Matrix

The system executes a process or methodology for the Attractiveness Matrix that:
1. Rank each potential option high, medium, or low in terms of how well the option meets Criteria 1.
2. Rank each potential option high, medium, or low in terms of how well it meets Criteria 2.
3. Plot each option within the Attractiveness Matrix as shown in the figure below.

The options appearing in the upper right hand portion of the matrix are the “attractive” options. Those placed toward the lower left are considered “not attractive.” In the Illustrative Example provided blow, green beans and dairy best satisfy the two selected criteria.

Attractiveness Matrix

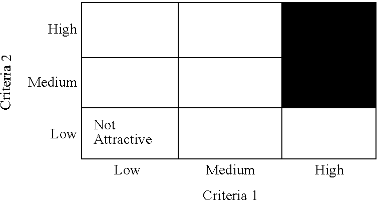

Illustrative Example of Attractiveness Matrix

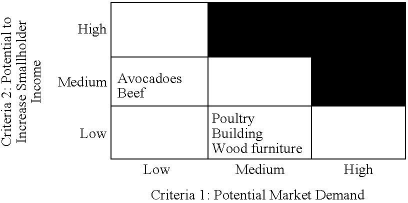

Weighted Ranking Methodology

The Weighted Ranking methodology provides a systematic way to compare options and facilitates the decision process by forcing assumptions to be clearly stated, allowing the incorporation of both qualitative and quantitative assessments, and revealing the sensitivity of the final outcome to the various assumptions and assessments made in the analysis. The example below uses hypothetical data to assess potential project areas.

1. Assess the Importance of Criteria

Selected criteria are assigned a weight, based on project staff assessment of the importance of that criterion. Weights are as follows:
Very Important=5, Somewhat Important=4, Neither Important nor Unimportant=3
Unimportant=2, Almost no Importance=1, Completely Unimportant=0
   (criteria to which the system assigns a weight of “0” is unimportant and is dropped.)

Example Weights:
1. Maximum annual depth of water table: 5
2. Average literacy rate: 1
3. Average time to get to nearest urban market: 3
4. Availability of transport connections to international export market: 0
5. Number of days/year when temperatures are below freezing: 3
6. Existing local facilities that offer microcredit to smallholders: 4
7. Percentage of households that earn their livelihood from agriculture: 5

2. Assess How Well Each Area Satisfies Each Criterion

For each criterion, assign a value to every candidate area according to how well that area satisfies the criterion. This value, or “score,” represents the extent to which each area offers project success, as defined by that criterion alone. Scores are assigned as follows:
Very Well=5, Fairly Well=4, OK=3, Poorly=2, Very Poorly=1
   Example Area Values for the Criterion: “Average time to get to nearest urban market”:

| | |
|---|---|
| 1 | Area A (time = 1.5 hours): 3 |
| 2 | Area B (time = 0.25 hours): 5 |
| 3 | Area C (time = 1.8 hours): 3 |
| 4 | Area D (time = 0.75 hours): 4 |

Note that project staff judge how well each area offers project success as defined by each criterion. In the above example, staff judged the time to access urban markets for each of the four areas and decided that Area B (0.25 hrs travel time) satisfies “access to urban markets” very well (score=5) and Area B (1.8 hr travel time) satisfies this criterion at an “OK” level (score=3).

3. Calculate Results for Each Criterion

The system calculates results for each criterion by multiplying the weight assigned to each criterion by the score for how well each area satisfies that criterion. In the example provided below, the criterion “Average time to get to nearest urban market” was assigned a weight of 3 (Neither important nor Unimportant). Area A, with a travel time of 1.8 hours, scored 3 (“OK”) for this criterion. To determine the results for Area A, the weight of 3 is multiplied by the score of 3, for a result of 9 for Area A.

| | |
|---|---|
| 1 | Area A: 3 × 3 = 9 |
| 2 | Area B: 3 × 5 = 15 |
| 3 | Area C: 3 × 3 = 9 |
| 4 | Area D: 3 × 4 = 12 |

The example below focuses on the criterion “Percentage of households that earn their livelihood from agriculture” (weight=5). The scores for this criterion are the percentage of the population working in agriculture in the different areas. The result for each area is calculated by multiplying the weight for each criterion by the percentage of the population that fits that criterion.
Example calculation for “Percentage of households that earn their livelihood from agriculture” (weight=5)
   1. Area A (%=85): 5×4=20
   2. Area B (%=20): 5×1=5
   3. Area C (%=95): 5×5=25
   4. Area D (%=65): 5×3=15

3. Calculate the Total Score for Each Area

In order to compare the different areas, results for each area from the above step are added together for a total score. In the example below, the Area A result for the criterion “Average time to get to nearest urban market” (Result=9) is added to the Area A result for the criterion “Percentage of households that earn their livelihood from agriculture” (Result=20), for a total score of 29 for Area A.
Example total scoring for each area:

| | |
|---|---|
| 1 | Area A: 9 + 20 = 29 |
| 2 | Area B: 15 + 5 = 20 |
| 3 | Area C: 9 + 25 = 34 |
| 4 | Area D: 12 + 15 = 27 |

4. Rank Areas and Review Results

Rank the areas highest to lowest according to Total Score calculated above. The higher the Total Score for an area is, the more preferable that area will be for a project intervention that satisfies the selected criteria.
Example ranking:

| | |
|---|---|
| 1 | Area C: Total Score = 34 (highest rank) |
| 2 | Area A: Total Score = 29 (2^{nd} ranking) |
| 3 | Area D: Total Score = 27 (3^{rd} ranking) |
| 4 | Area B: Total score = 20 (4^{th} ranking) |

After completing these calculations, project staff review the rankings to assess whether the results seem reasonable. This “reality check” is useful to ensure that an arithmetic procedure does not produce unrealistic results. If this does occur, project staff should review the assignment of criteria weights and scores, and repeat the necessary steps of the procedure.

Table A1 includes the example data used throughout this discussion and Table A2 provides an example worksheet that can be used to implement this procedure. This example worksheet is limited to four criteria and four potential project areas, but it can be expanded as needed.

TABLE A1
Weighted Ranking Methodology - Example Data

| | Criteria | | | | | | | |
|---|---|---|---|---|---|---|---|---|
| | | | | Criterion | | | | |
| | Criterion | | | 4: | | | | Criterion |
| | 1: | Criterion | Criterion | Percentage | | | Criterion | 8: |
| | Average | 2: | 3: | of | | | 7: | Number |
| | distance | Average | Average | households | | Criterion | Households | of high |
| | to | time to | annual | whose | | 6: | currently | value |
| | nearest | nearest | water | primary | Criterion | Extent | using | crops sold |
| | urban | urban | table | livelihood | 5: | of paved | drip | in local |
| | market | market | depth | is | Population | roads | irrigation | and urban |
| Area | (km) | (hours) | (meters) | agriculture | (thousands) | (km) | (%) | markets |
| Area A | 10 | 1.5 | 15 | 85 | 35 | 55 | 20 | 5 |
| Area B | 0.5 | 0.25 | 2.5 | 20 | 80 | 150 | 45 | 10 |
| Area C | 35 | 1.8 | 35 | 95 | 20 | 75 | 15 | 2 |
| Area D | 15 | 0.75 | 5 | 65 | 45 | 100 | 30 | 5 |

TABLE A2
Weighted Ranking Methodology

| | | | | | | | |
|---|---|---|---|---|---|---|---|
| | | | | | | | Sum |
| | | | Product: | | | Product: | of shaded |
| | | | Criterion | | | Criterion | columns |
| | Criterion 1 | Area | 1 × Area | Criterion 2 | Area | 2 × area | (Total |
| Area | Weight | Score 1 | Score 1 | Weight | Score 2 | Score 2 | Score) |

Area 1
Area 2
Area 3
Area 4

Ranking Order
   District 1: ______
   District 2: ______
   District 3: ______
   District 4: ______

The PRISM system then generates an Intervention process to address constraints that prevent smallholders from increasing their income and then to identify interventions that address these constraints. In one embodiment, the following process is used to develop interventions that address constraints:
1. List all identified constraints
2. Identify the most critical constraints for smallholders
3. Group the critical constraints into the following categories: input, on-farm, and output.
4. Identify existing or probable providers of services that will address identified constraints.
5. Explore market mechanisms for needed products and services, including market assessment and mode of payment.

The tables below present exemplary constraints identified for India smallholders at the input, on-farm and output levels. For each constraint, the system identified services, providers of those services, recipients of the service and how the services would be paid.

TABLE A3
Services to Address Input Constraints

| Critical Input | Service to Address | | Recipient of | Payment for |
|---|---|---|---|---|
| Constraint | Constraint | Service Provider | Service | Service |
| Poor quality | Quality seeds | Agri-input dealer | Farmer | Direct by |
| seeds | | | | farmer |
| Lack of quality | Quality | Nursery | Farmer | Direct by |
| saplings | saplings | | | farmer |
| Poor quality | Appropriate | Agri-input dealer | Farmer | Direct by |
| fertilizer and | quality and | | | farmer |
| pesticide and | quantity | | | |
| in amounts not | fertilizer and | | | |
| useable by | pesticide | | | |
| small farmer | | | | |
| Lack of water | Water tech | Manufacturer | Distributor | Direct by |
| control | system | | | distributor |
| | Water tech | Distributor | Dealer | Direct by |
| | system | | | dealer |
| | Water tech | Dealer | Farmer | Direct by |
| | system | | | farmer |
| | System | Installer/assembler | Farmer | Direct by |
| | installation | | | farmer |

TABLE
Services to Address On-Farm Constraints

| Critical On- | Service to | | | |
|---|---|---|---|---|
| Farm | Address | Service | Recipient of | Payment for |
| Constraint | Constraint | Provider | Service | Service |
| | Agricultural | Agri-input | Farmer | Embedded |
| | Tech | dealer | | |
| | Crop selection | Agri-input | Farmer | Embedded |
| | | dealer | | |
| | Crop selection | K.V.K | Farmer | Free |

TABLE
Services to Address Output Constraints

| Critical Output | Service to Address | | Recipient of | Payment for |
|---|---|---|---|---|
| Constraint | Constraint | Service Provider | Service | Service |
| Lack of market | Market | Internet kiosk | Farmer | Direct by |
| information | information | | | farmer |
| | Market | Agri-Watch | Farmer | Direct by |
| | information | | | farmer |
| | Market linkages | IDE | Farmer | Free |
| Lack of value | Value addition | Local experts | Farmer | Eventually paid |
| addition to | training | | | by farmer |
| farmer products | | | | |

Next, the system selects a Business Services Intervention strategy. Business Services are enterprises that provide services to members of the input-production-output chain to help them manage and expand their operations. The section below outlines a process for recognizing, assessing and selecting Business Services that meet the needs of smallholders and for identifying opportunities to increase the capacity of Business Services.

The system identifies Business Services that respond to the key leveraging constraints pinpointed in the “Smallholder Opportunity and Constraints Analysis” phase. Business services should increase the capacity of smallholders directly or through enterprises that serve smallholder needs. It is important to identify commercial business services that respond to subsector constraints rather than to address the constraint directly. This ensures sustainable solutions to constraints; avoids market distortions; expands outreach through a number of providers; and generates in-depth analysis and knowledge of private sector services available.

Next, the system determines selection criteria for comparing and selecting business services. Possible criteria include:

Number of smallholders or enterprises that will benefit

Increase in income/efficiency/effectiveness of smallholders or enterprises

Increase in smallholders' income

Positive or neutral environmental/social impacts

The Business Services are selected using the Weighted Ranking Method as discussed above if there are more than two criteria or Attractiveness Matrixif there are only two important criteria. The system then assesses the selected Business Services to understand demand, identify potential providers, and determine feasibility. The table below summarizes information required for the assessment, methods for collecting the information and examples of Business Service providers.

### Information Gathering on Business Services

| Information Required | Methods of Collecting | Examples |
|---|---|---|
| for Business | Business Service | of Business |
| Service Assessment | Information | Service Providers |
| Existing providers | Focus groups | Input suppliers |
| Market size and | Surveys/questionnaires | Produce buyers |
| penetration | of Business Service users | Brokers/traders |
| Frequency of use | Surveys/questionnaires | Exporters |
| Constraints and | of Business Service | Transporters |
| opportunities on the | providers | Associations |
| demand side (Business | Business plans or pilot | Training |
| Service users) | testing to determine | organizations |
| Constraints and | feasibility | |
| opportunities on the supply | | |
| side (Business Service | | |
| providers) | | |
| Awareness of the business | | |
| service among potential | | |
| users | | |
| Satisfaction with the | | |
| business service among | | |
| users | | |
| How costs are covered (fee | | |
| for service or embedded) | | |
| Proposed providers to | | |
| target for intervention | | |

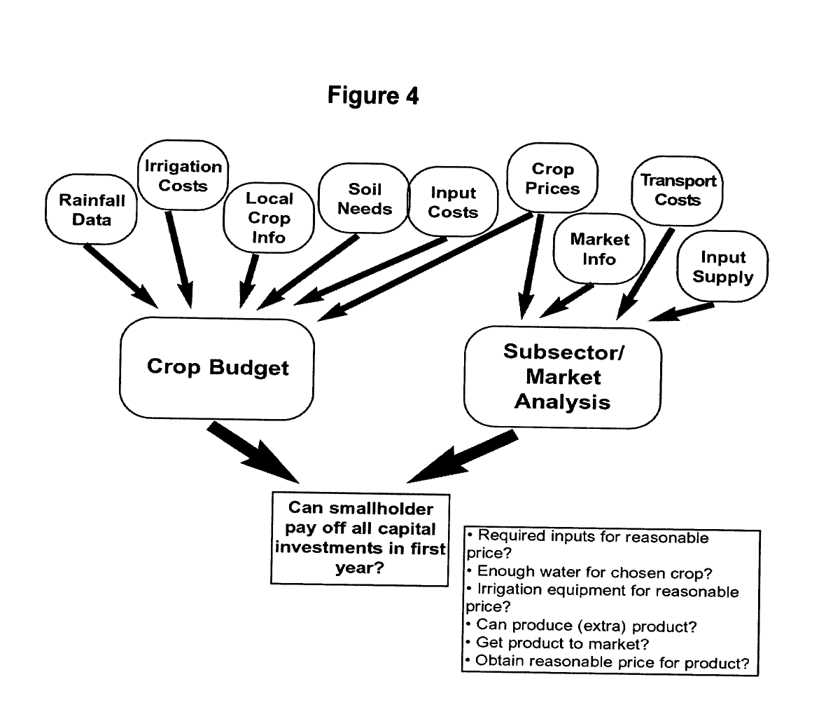

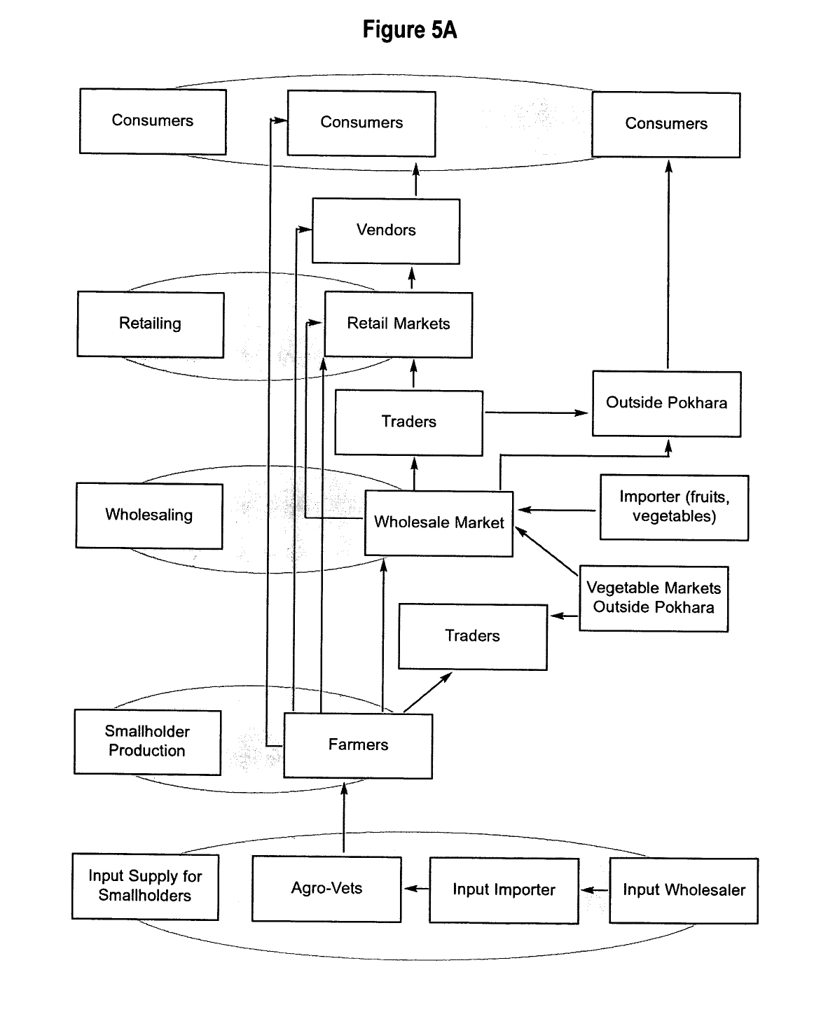

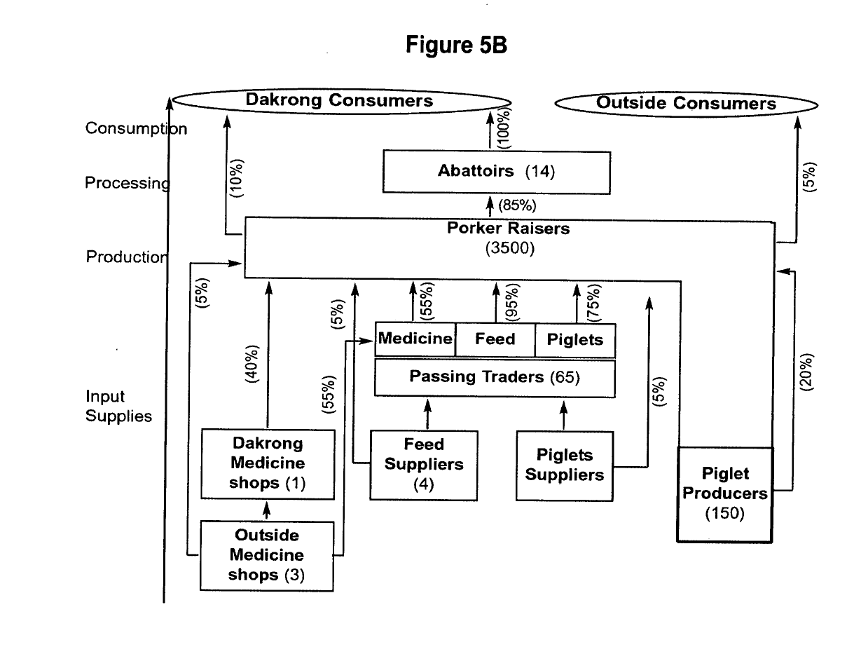

One factor in sub-sector selection is the time needed for smallholders to benefit. To engage in a PRISM intervention, a farmer often buys items that she or he does not usually buy, including irrigation equipment and seeds to grow produce for new markets. It is important to calculate how much money a farmer will earn through the intervention and when the farmer will pay for the new items and earn a profit. Calculating this requires a good understanding of the situation of smallholders. It also requires quantifying factors involved in smallholder production and marketing and using this information to develop detailed crop budgets and sub-sector analyses, which is shown in FIG. 4. Examplary sub-sector maps generated by the process of FIG. 4 are shown in FIGS. 5A and 5B, respectively.

In one implementation, the system generates a portfolio of sub-sectors; one that mixes short, medium, and long term; medium and high return; low and medium risk as follows:

| | | Medium | |
|---|---|---|---|
| | | Potential Return | High Potential Return |
| Short | Low risk | Improve staple crop | |
| Term | | production for food | |
| | | security | |
| | Med Risk | Improve productivity | |
| | | of existing income | |
| | | crops/products | |
| Medium | Low risk | Expand market for | Add value to existing crops |
| Term | | existing crops to | through processing |
| | | new areas | |
| | Med Risk | Introduce new crop | Introduce new crop for |
| | | for local market | expanding market |
| Long | Low risk | | Tree crops for children's |
| Term | | | education (e.g., teak) |
| | Med Risk | | Long-term investment crops |
| | | | (e.g., coffee) |

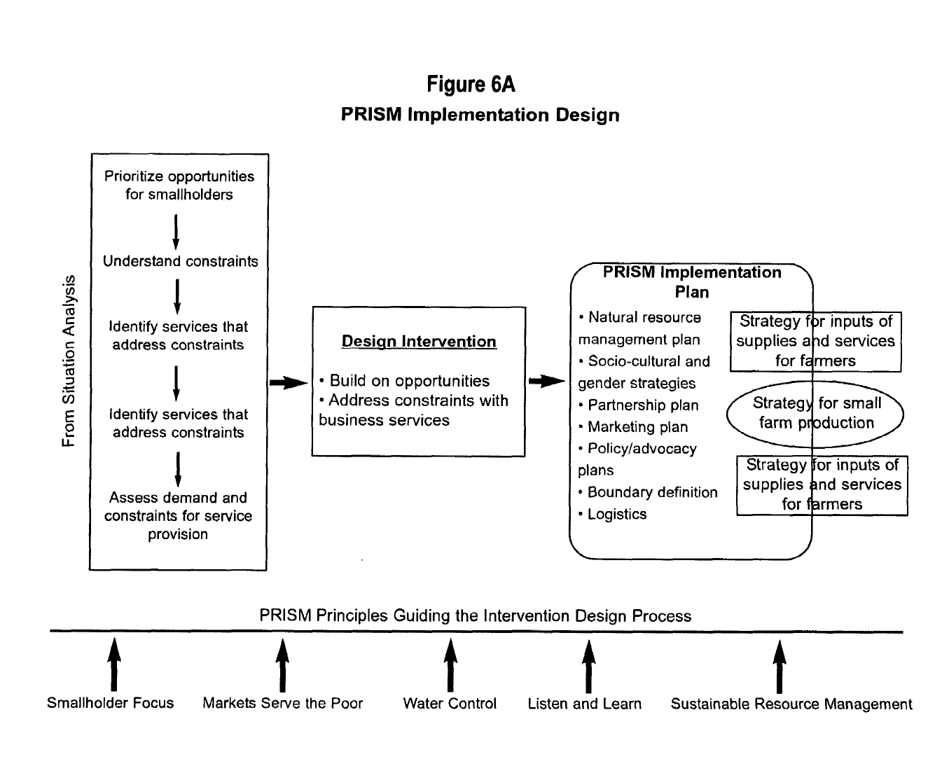

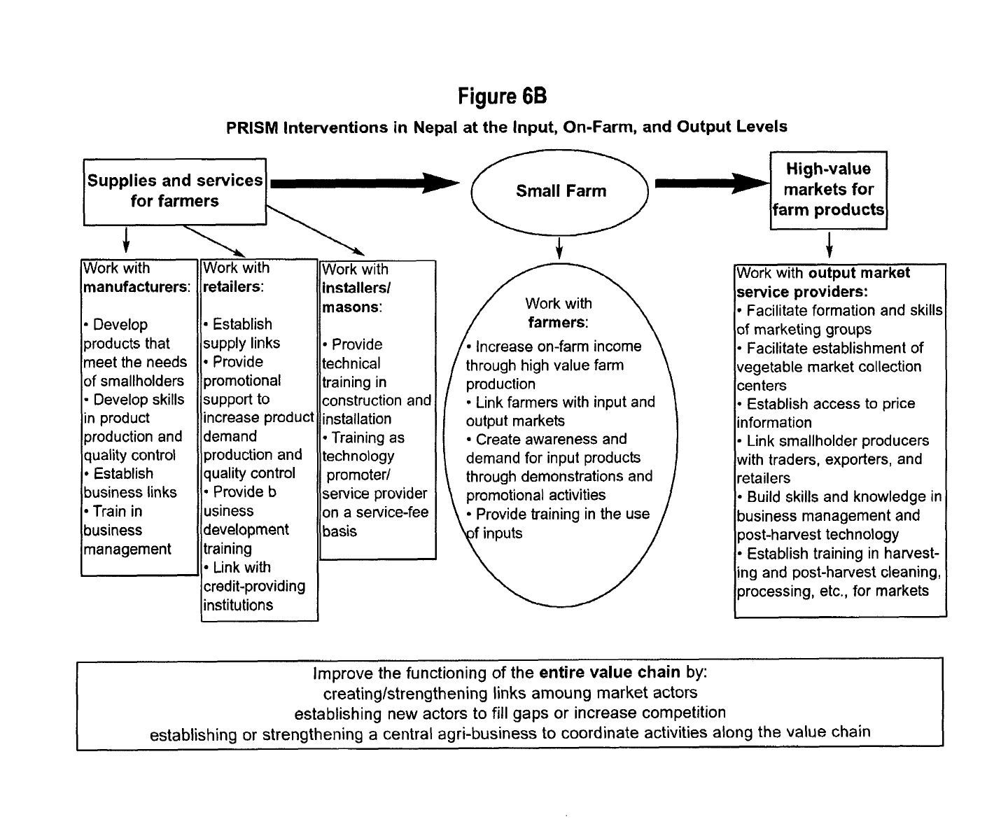

FIG. 6A illustrates an exemplary intervention design process. The PRISM intervention involves bringing together identified market opportunities and addressing constraints that limit smallholders from engaging in these opportunities. In one implementation, the following process is used to assist in developing an intervention:

i. Prioritize opportunities for smallholders and related constraints that were identified in the Situation Analysis phase.

ii. Based on the assessment of services and supplies for smallholders conducted in the Situation Analysis phase, list services that address identified constraints. Summarize demand for those services and list constraints that restrict services from meeting the needs of smallholders.

iii. Identify interventions that build on identified opportunities and address the constraints. In many countries, the system develops intervention measures that address constraints at the input, on-farm and output levels. FIG. 6B illustrates an example of this in Nepal. When identifying potential interventions, it can be useful to look for a business or service that, when activated or promoted, improves the functioning of the entire value chain.

iv. Identify activities necessary for the intervention.

v. Develop a PRISM Implementation Plan, which is explained below.

vi. Discuss and validate the Implementation Plan with stakeholders.

In one embodiment, the system applies the following guidelines in identifying potential interventions:
Facilitate business service development rather than providing services directly, which can lead to market distortions and inefficient use of resources. At times, particularly in very underdeveloped markets, it may be necessary to support a particular business development service provider or launch a new service or model to demonstrate its potential, but as the provider or service becomes viable, it is important to switch to the role of facilitator.
Develop linkages with other agents who can provide the required services. For example, a variety of financial institutions, including credit unions, co-ops, commercial banks; grants, can provide financial services to smallholder, including micro-finance, savings, credit, transfers and payment services, micro-insurance, and micro-leasing.
Identify interventions that address constraints identified in the Business Services assessment.
Target interventions at pre- and post-service delivery (avoid direct service delivery). Examples of pre-delivery activities include development of service products, test marketing, capacity building, raising awareness. An example of a post-delivery activity is gathering consumer feedback.
Work toward sustainability. Sustainability is the “long-term availability of a category of services in a particular business service market through unsubsidized, commercial channels”. To encourage sustainability, it is important to have an exit strategy, which is defined as a strategy whereby time-bound interventions undertaken by a facilitator help ensure that Business Services are sustainable through market forces once the interventions end. The exit strategy should be linked to achievement of the intervention's market development objectives. The challenge is to assess the market objectively to determine when it has reached a sustainable level.
Separate the role of the Business Services provider and facilitator. Because facilitators usually have a development agenda and suppliers a commercial agenda, mixing the roles often leads to ineffective programs and inefficient use of funds. If facilitators are publicly funded, they should disappear as the market develops and suppliers or other permanent market actors take over their functions.
Promote competition, efficiency, and innovation in the provision of Business Services.
Maintain a commercial orientation with smallholders and small and medium sized enterprises. Examples of techniques to ensure commercial orientation are cost-sharing mechanisms, which ensure the service providers' commitment and investment in the service, as well as written agreements that define the roles and responsibilities of the provider and facilitator for each activity.
Remain flexible and responsive to opportunities. This is important because subsectors are dynamic and constantly changing because learning takes place with market actors as the program progresses. Facilitators should take advantage of opportunities and change strategies as appropriate in response to these changes.
Coordinate efforts of donors, government, and other stakeholders in order to avoid conflicting messages.

Determine Selection Criteria for Selecting Business Services Interventions

Determine selection criteria for comparing and selecting the business service interventions. Possible criteria include:

Number of SMEs (including smallholders) that will benefit

Increase in income/efficiency/effectiveness of SMEs

Cost-effectiveness of intervention

Chances of intervention resulting is sustainable business service

Capacity of existing facilitators to implement/manage the intervention

Synergy of interventions among various business services

Feasibility of intervention (time frame, resource availability, donor interest)

Developing an Intervention to Address Smallholder Constraints

| Constraints | | Intervention |
|---|---|---|
| Input | High input cost for | Promote vermi-wash, |
| Constraints | fertilize, pesticide, etc. | vermi-compost, neem oil |
| | No awareness or access to | and cake |
| | low-cost drop irrigation | Promote KB drip |
| | technology | irrigation |
| On-farm | Lack of knowledge about | Promote integrated pest |
| Constraints | appropriate agronomic | management, organize |
| | practices | farmer training by local |
| | Lack of knowledge about | experts |
| | alternative crops | Exposure visits and |
| | | interaction with |
| | | entrepreneurial farmers |
| | | Promote input availability |
| | | (seed, sapling) |
| | | Promote alternative crops |
| Output | Lack of price information | Promote ICT usage for |
| constraints | in alternative markets | price exploration |
| | Heavy dependence on | Promote off-season crops |
| | seasonal crops, which | Promote crop |
| | creates a dip in the market | diversification for risk |
| | price | hedging |
| | | Promote bamboo, shisham |
| | | for long-term security |

| | | | |
|---|---|---|---|
| SERVICE | PROVIDER | RECEPIENT | PAYMENT |

Model - input

| | | | |
|---|---|---|---|
| SEED | AGRI-INPUT DEALER | FARMER | DIRECT BY |
| | | | FARMER |
| SAPLING | NURSERY | FARMER | DIRECT BY |
| | | | FARMER |
| FERTILIZER | AGRI-INPUT | FARMER | DIRECT BY |
| PESTICIDE | DEALER | | FARMER |
| WATER TECH | MANUFACTURER | DISTRIBUTOR | DIRECT BY |
| SYSTEM | | | DISTRIBUTOR |
| WATER TECH | DISTRIBUTOR | DEALER | DIRECT BY |
| SYSTEM | | | DEALER |
| WATER TECH | DEALER | FARMER | DIRECT BY |
| SYSTEM | | | FARMER |
| SYSTEM | INSTALLER/ | FARMER | DIRECT BY |
| INSTALLATION/SAS | ASSEMBLER | | FARMER |

On-Farm

| | | | |
|---|---|---|---|
| AGRI. TECH | AGRI INPUT | FARMER | EMBEDDED |
| | DEALER | | |
| CROP | AGRI INPUT | FARMER | EMBEDDED |
| SELECTION | DEALER | | |
| CONCEPT | | | |
| CROP | K.V.K. | FARMER | FREE |
| SELECTION | | | |
| CONCEPT | | | |

Output

| | | | |
|---|---|---|---|
| MARKET | INTERNET KIOSK | FARMER | DIRECT BY |
| INFO. | | | FARMER |
| MARKET | AGRIWATCH | FARMER | DIRECT BY |
| INFO. | | | FARMER |
| Market | IDE | Farmer | Free |
| Linkages | | | |
| Value | Local Experts | Farmer | Eventually Paid |
| Addition Trg. | | | Farmer |

Examples of Business Services that Address Key Constraints

| Type of Constraint | Business Service |
|---|---|
| 1. Technology/product | Access to information on new |
| development | technologies |
| | Product research and development for |
| | new technology/product development |
| | Access to vocational training |
| | Access to machine and equipment |
| | rental services |
| 2. Market Access | Identification of new markets |
| | Providing linkages to buyers |
| | Provision of market research services |
| | Access to export services |
| | Access to information services |
| 3. Input supply | Access economies of scale in supply |
| | purchasing |
| | Access to material inputs |
| | Brokerage of linkages with suppliers |
| 4. Finance | Provide linkages with financial |
| | institutions |
| | Training in procedures/requirements for |
| | accessing credit |
| | Access to supplier credit |
| 5. Policy | Training in advocacy |
| | Policy/advocating for improved |
| | regulatory environment |
| | Access to policy studies |
| 6. Management and | Training in management and business |
| organization | skills |
| | Access to development of business |
| | plans |
| | Provision of accounting services |
| | Developing management information |
| | systems |

Each of the business services identified above may require additional detailing. For example, to address the “Input supply” constraint, one potential business service listed is accessing economies of scale in supply purchasing. Additional details on how to accomplish this can include:

Provide advice on the formation of groups of smallholder enterprises, including trade group associations, in order to group purchases and gain more favorable prices and/or create new supply sources.

Assist the enterprises to conduct market research, organize participants, and/or negotiate financing terms with the banks and/or wholesalers.

The system also performs Gender Analysis, which is a cultural and societal study, at the productive, household and community levels, of:
the different roles that women and men play;
what resources, activities and benefits women and men have access to and control over;
the daily workloads of women and men; and
the practical and strategic needs, interests and priorities of women and men.
the capacity of institutions, the private sector and other organizations to program for gender equality in order to assess the system's role in addressing these issues.

To meet the goal of increased incomes for women and men smallholders, PRISM system integrates gender analysis in project planning, implementation and monitoring. Information gathered through gender analysis is used to identify objectives, constraints, and opportunities for integrating women into market systems development programming. This ensures that the intervention benefits women and respects cultural norms. The information can also be utilized to establish a baseline and gender indicators against which to monitor gender equality results achieved over time. Gender analysis can be used to:

Promote equal access to and control of land and other productive resources.

Enhance women's opportunities for employment and income.

Increase women's control over discretionary income generated from project interventions.

Increase skills training and capacity development opportunities for women.

Improve access to and control over credit, training, and services for women entrepreneurs.

Reduce women's workloads.

Increase women's participation in decision- and policy-making in the private sector and participation in decision- and policy-making in the household.

Strengthen the capacity of partner institutions, governments and civil society to promote, design and implement policies, programs and projects that reflect the needs, priorities and interests of women.

The system analyzes the following factors:
Access (use), control (decision-making) and “ownership” of the land and water, as well as other farm, business and household assets;
   Do women and men benefit equitably from the intervention? If not, could a different strategy in intervention distribute the benefits more equally? What are the benefits for each? What are the adverse effects and how could these be mitigated?
Management of the land and/or business;
   With the introduction of irrigation technologies and high-value crop production, how will the decision as to crop location, number and size of productive plots be made and who will be involved in making these decisions? In the small to medium input enterprises, how will the decisions be made regarding which product to carry, pricing, etc and who will be involved in making these decisions?
Provision of labor on the farm and/or business;
   What is the workload of women and men in the process of food production and input or output marketing? Will the introduction of smallholder irrigation and high-value crops increase the workload (time spent in irrigation, caring for, harvesting and marketing crops) for either the women or men?
Rain-fed and irrigated planting decisions—food security and cash crops;
   What is the involvement of women and men in deciding which crops to irrigate and which to grow as rain-fed? What crops are considered women's/men's crops? What impacts can the decisions made affect the production of food security and cash crops?
Access and participation in training—farm management/production and business management;
   Based on involvement in the given activity that the training is covering at the farm or business level, how can the training sessions and site cross-visits ensure equitable participation by both genders? What are the constraints to ensure more equitable participation and how can the training sessions be planned in order to mitigate this problem?
Access to credit for the purchase of inputs such as irrigation technologies, seeds, fertilizers—smallholders and service providers;
   Who is requesting the credit and who will be using the credit for their economic activity? How can the constraints be mitigated to ensure equitable access to credit?
Marketing of the crops—food security and cash;
   Who markets the food and cash crops and how and where is each type of crop marketed? Who receives the cash income received through the marketing of the crops?
Family cash income—farming and business;
   Who makes the decision as to how the family income is expended? What are the expenditure priorities of women? Of men? How do they view each others' priorities?
Responsibility for care and maintenance of the family (including the ill) and the home;
   Who carries the primary responsibility for the maintenance and care of the family and household? When illness strikes, who provides the primary care for the ill? Will the planned intervention put an additional strain on family/household care and management? Who attends and assists in the preparation of funerals?
Participation at the community level through membership and decision-making roles;
   Who is involved in organizations at the community level and what is the level of involvement? What decision-making roles are held by each?
Priorities, opportunities, constraints (problems) and solutions.
   What are the priorities for each gender and what are the opportunities and constraints in running their farm or enterprise? How do they mitigate the problems encountered and what solutions could they identify? What are their views on the priorities, opportunities and constraints of the opposite gender?
Attitudes of staff and other service providers on gender issues;
   What level of comfort is there in the organization, internally, across gender lines? Is affirmative action implemented in the hiring of staff to work towards greater equity in the staff composition? What training is provided to staff and smallholder service providers to ensure healthy gender relations and a greater comfort level with beneficiaries of the opposite gender?

The tools below were developed to collect information gender analysis information at the farm level. These tools can be modified to suit the context and intervention. The tools analyze the following data:
Gender Analysis Information #1—Household Description for Farming Families
   Statistical information on the make-up and described assets of the household. Note that the head of the household can be defined by gender (either female or male), described by “ownership” of land (who has tenure or title) and/or economic activity (who provides most of the labor in the farming operation).
Gender Analysis Information #2—Productive, Household and Community Roles
   A break-down of tasks completed by the woman/women and the man in the economic, home and community activities of the household. On the scale of 0 to 4, 0 represents 0% participation in the activity, 2 represents 50% and 4 represents 100%, etc. Dependant on the educational level of the respondents, sticks broken into proportionate pieces that represent 25%, 50%, 75% and 100% can be used.
Gender Analysis Information #3—Access to and Control Over Resources
   A break-down of access to (right/opportunity to use the resource/benefit) and control over (authority to make decisions about the use of the resource/benefit) in the productive, household and community activities. On the scale of 0 to 4, 4 represents full right to use (access), and equity in decision-making (control). 2 represents 50% right to use (access) and equity in decision-making 50% of the time (control).
Gender Analysis Information #4—Priorities, Opportunities, Problems and Solutions
   How are these viewed by each gender and through the eyes of the opposite gender?
Gender Analysis Information #5 & #6—Daily Activities Analysis for Women and Men
   Using a 24-hour clock, this analysis should be completed for both the Dry Season (G Gender Analysis Information #5) and Rainy Season (Gender Analysis Information #6) to assist in the analysis of women and men's daily workloads.
Gender Analysis Information #7—Main Source of Family Income and Expenditure
   According to women, what are the main sources of income for women/for men. According to men, what are the main sources of income for women/for men. Similarly information can be gathered on the items of expenditure. 1 represents the greatest source of income/expenditure identified.

Next, the system optionally analyzes potential Partnerships in PRISM. In some situations, it is necessary to involve other organizations to fulfill the many different roles of creating sustainable smallholder market systems. These roles may involve facilitation or direct provision (technology, finance, information, policy) at multiple levels (input, on-farm, output), to the development of pro-poor smallholder markets. Partnerships also ensure that indigenous knowledge and experience are incorporated into project design, encourage local organizations to take ownership of the process, and build local capacity for the future.

The PRISM system enables the formation and maintenance of “platforms”, or consortiums, upon which participating organizations work together toward a common goal of sustainable market participation by the rural poor. Such platforms for collaboration and coordination generate synergy by combining the efforts of numerous players in a targeted fashion.

For example, in Nepal, the exclusion of the private sector has been one of the main drawbacks of govt. development programs in the past. Hence, the system supports the networking of partners upon which participating organizations—including NGO, government, research, and private sector organizations—can work together toward the common goal of sustainable market development. The participating organizations are expected to build the capacity of the real market actors: the smallholders and small enterprises in the input and output chain.

In one embodiment, a distinction is made between two types of partners, Direct Service Providers and Facilitators, as explained below, although the distinction between the two types is not always obvious. Different partner types and different partner organizations may be brought into the PRISM process at different points of the project cycle and partners may participate to a greater or lesser extent in individual project formulation and implementation activities. Implementer partners will tend to be involved earlier and in a broader range of activities, while Direct Service Providers will tend to be involved later and in more specialized areas.

Direct Service Providers are market actors aligned with the project objectives who receive support from the project to increase their efficiency and effectiveness in their roles within the smallholder market system. These actors will remain in the project area and continue to function within the smallholder market system providing affordable, appropriate, and sustainable goods and services to smallholders. These partners primarily consist of local organizations, including private enterprises, micro-finance institutions, business associations, farmer groups, and government agencies.

Facilitators assist in the development of smallholder markets by supporting Direct Service Providers. Support may take the form of training, research and development, establishing market and information linkages, awareness raising, demand creation, and policy advocacy. Facilitator partners will include organizations that provide facilitation services. Some of these will receive strategic support from the project during the start-up phase. The role of facilitators is time limited; they will phase-out their activities as market systems begin to function on their own. Facilitators may be national, regional, or global in scope and may include NGO, government, donor, or research organizations. Potential partners may include government, civil society, donors, and/or private enterprises. Selecting partners is largely dependent on local needs and capabilities. Careful selection of partners will ensure that the full range of identified constraints are adequately resolved to develop sustainable smallholder market systems, and that the process of smallholder market development will become self-sustaining over time. Partners may be selected based on a search of options against a specific set of expertise or experience required. They may also appear opportunistically in the context of a given initiative. Potential partners may also be identified through networking, workshops, or tender. The task is to judge whether they are suitable, will add value to the whole and whether they bring new opportunities.

The PRISM approach benefits the rural poor through:

Market research for market-led production.

Small-farm producers seldom grow products based on market demand. To ensure that farmers grow products that are in demand in markets, market research and analysis are done to understand demand for small-farm products. The system then works with small farm families to address constraints and capitalize on market opportunities, generating profits for small-farm families.

Pro-poor technology innovation and marketing

Farmers require specific products (e.g. small-scale irrigation equipment) to improve household productivity and generate income. Often these products are not available, are not the right size, or are too expensive for poor farmers. To address this issue, the system develops and promotes affordable, small-scale technologies. The system also establishes networks of local enterprises that make, distribute, sell, install and repair these technologies. This results in lower costs to farmers, sustainable supplies of necessary products and equipment, available parts and services, and thriving rural economies. Where local enterprises are already established, the system strengthens the capacity of these businesses; improves market mechanisms for product development, quality control and delivery mechanisms; promotes competitiveness among businesses; stimulates demand for the product; and expands the coverage of the businesses in order to meet the needs of many rural poor. Strengthening and promoting private businesses helps to create strong and sustainable market systems.

Training and services in farm production and processing The system builds the capacity of farmer groups, government and private businesses to supply services that increase smallholder's income. Services include training in crop selection, production, post-harvest handling, processing, and how to use market information. The system also encourages private provision of extension services, recovering costs for these services through fees.

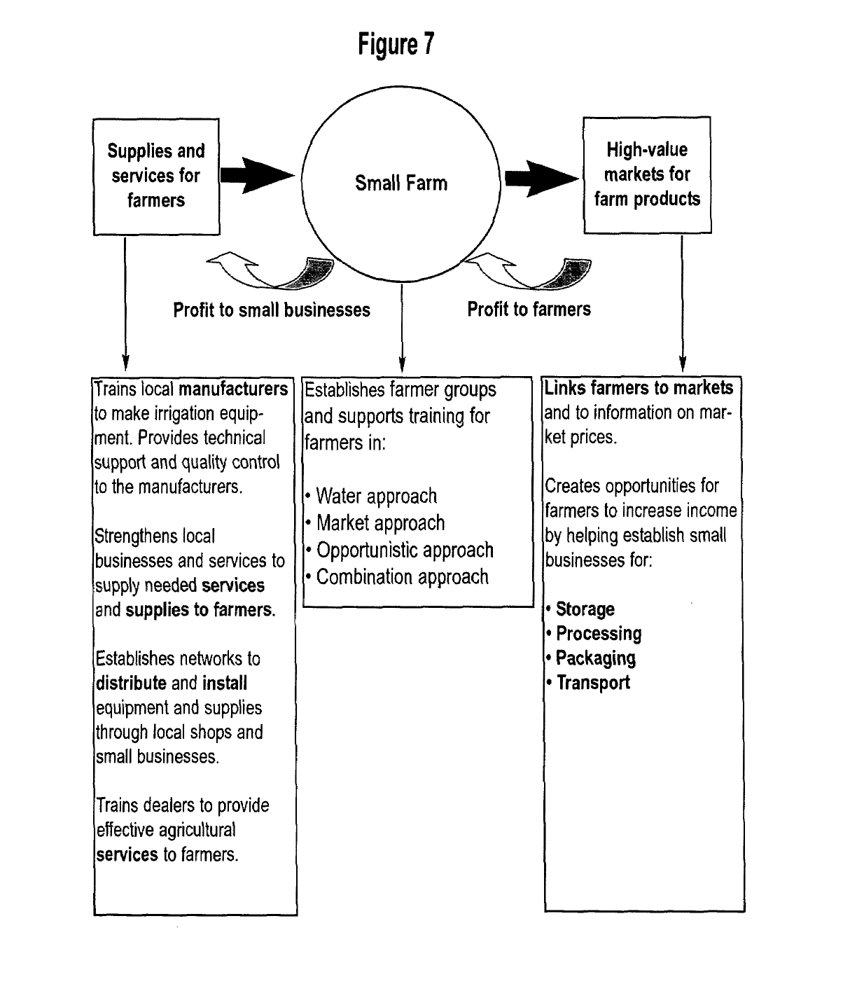

As shown in FIG. 7, the PRISM system creates an integrated system of private-sector enterprises that include input suppliers, small-farm families, and output markets. The system analyzes four basic questions:
What market opportunities can small farm families take advantage of?
What constraints prevent small farm families from participating in these market opportunities?
What small enterprises exist or can be created to address those constraints?
What assistance is required to help those enterprises better serve the needs of small farm families?

The PRISM projects can use one of the following approaches:

Water Approach: With this approach, the system examines untapped, underutilized, or inefficiently-used water resources in areas where irrigation or improved irrigation practices would provide significant benefits for large numbers of smallholders. For example, in India, the system promotes drip irrigation systems in areas where current wells no longer produce enough water to support conventional surface irrigation systems. In Nepal, smallholders needed technologies that were low-cost, manually-operated, easily maintained and that provided a rapid and high return on investment. The system therefore developed drip and micro-sprinkler systems and low-cost water storage tanks linked to micro-irrigation of high-value crops in the hills. The system also developed community-based and community-managed hybrid water supply schemes that supply water both for household use and for micro-irrigation of high value crops in the hills of Nepal.

Market Approach: Using this approach, the system searches for crops that many smallholders can produce and sell for profit. This approach involves understanding market demand and what smallholders can produce to meet market demand. Strategies are also developed to overcome obstacles to smallholder market production. For example, water was not a constraint in Bangladesh, so the system focused on this market approach. Using this approach, the system studied options for smallholder market-oriented production, including onions, potatoes, vegetables and pond fishery. Based on these studies, the system determined that smallholders would generate more income by growing and selling vegetables and through pond fishery, so the system developed a PRISM project focused on these sectors.

Opportunistic Approach: In some situations, water is not a constraint, but other constraints limit farmers. For example, farmers may lack credit, critical technology or knowledge of improved agriculture methods. The opportunistic approach involves identifying untapped, underutilized, and/or poorly utilized resources that—if more effectively utilized—could provide significant benefits. Because the key limitation varies from situation to situation, the PRISM intervention is opportunistic and entrepreneurial. The opportunistic approach may start by visiting poor rural communities and talking with community members, from the poorest to the wealthiest smallholders. The goal is to ask smallholders what limits their income, productivity or capacity to meet household food needs. In Myanmar, for example, the system first developed a strong, clear focus on target smallholder customers based on a combination of farming activity, irrigation methods, and connections to product markets. The system in Myanmar then focused on geographic areas where there were many of these smallholders. In Cambodia, smallholder identified the following constraints that limited their productivity:

Lack of water control in the dry season;

Lack of access to quality inputs (e.g. seeds) for farm production;

Lack of horticultural know-how;

Food security risk.

Using this knowledge of smallholder constraints in Cambodia, the system then worked with smallholders to overcome these constraints.

Combination Approach: The three approaches described above are often combined. For example, in Nepal, the system combined these approaches through:

Establishing supply chains for micro-irrigation and agricultural inputs, together with technical support, quality control, and training of dealers and sub-dealers to provide effective services to farmers.

Demand creation through social mobilization and through the provision of technical assistance to smallholders willing to adopt new ideas.

Market development through the establishment of collection centers for smallholder produce and through workshops to link traders to the collection centers.

Linking farmers to micro-credit sources.

Training farmers in green house management so that farmers can produce off-season in order to obtain the highest possible price.

Post-harvest processing of smallholder produce. In Bangladesh, after developing effective supply chains to provide smallholders with necessary inputs, the system then establishes needed services for farmers. These services are established in several ways: through embedded fees, informal fees or fee-based services. As a result, businesses providing services to smallholders earn a profit, which can help to ensure that the services will be available and will meet the needs of farmers in the future. Local factors will determine the most appropriate and effective combination of PRISM approaches. These factors may include culture, tradition, market conditions, government policy, expertise, experience, etc.

The invention has been described in terms of specific examples which are illustrative only and are not to be construed as limiting. The invention may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated, in, specially-designed application-specific integrated circuits (ASICs) or suitably programmed field programmable gate arrays (FPGAs).

From the foregoing disclosure and certain variations and modifications already disclosed therein for purposes of illustration, it will be evident to one skilled in the relevant art that they present inventive concepts that can be embodied in forms different from those described and it will be understood that the invention is intended to extend to such further variations. While the preferred forms of the invention have been shown in the drawings and described herein, the invention should not be construed as limited to the specific forms shown and described since variations of the preferred forms will be apparent to those skilled in the art. Thus the scope of the invention is defined by the following claims and their equivalents.

What is claimed is:

1. A computer-implemented method generating a plan to reduce poverty, comprising:
identifying market opportunities exploitable by one or more smallholders;
generating an intervention plan to assist the smallholders;
establishing a supply chain to deliver supplies to the smallholders and establishing a linkage with an output market; and
monitoring and evaluating the intervention plan.

2. The method of claim 1, comprising determining irrigation improvements.

3. The method of claim 2, comprising recommending drip irrigation in areas where wells no longer produce enough water to support conventional surface irrigation.

4. The method of claim 2, comprising recommending drip and micro-sprinkler systems and low-cost water storage tanks linked to micro-irrigation of high-value crops.

5. The method of claim 1, comprising determining market demands for crops that smallholders can produce and sell for profit.

6. The method of claim 1, comprising recommending opportunistic solutions to reduce poverty.

7. The method of claim 6, comprising identifying untapped, underutilized, or poorly utilized resources and recommending an effective utilization of the resources, the resources including credit, critical technology, knowledge of improved agriculture methods.

8. The method of claim 1, comprising optimizing a recommendation based on Smallholder Poverty Alleviation, Wealth Creation, Market Sustainability, Project Cost Effectiveness, Model Validation, Gender/Sociocultural Impact, and Environmental Impact.

9. The method of claim 1, comprising establishing supply chains for micro-irrigation and agricultural inputs, together with technical support, quality control, and training of dealers and sub-dealers to provide effective services to farmers.

10. The method of claim 1, comprising creating demand through social mobilization and through the provision of technical assistance to smallholders.

11. The method of claim 1, comprising performing market development through an establishment of collection centers for smallholder produce and through workshops to link traders to the collection centers.

12. The method of claim 1, comprising linking farmers to micro-credit sources.

13. The method of claim 1, comprising performing a gender analysis including a cultural and societal study.

14. The method of claim 13, further comprising analyzing roles that women and men play; resources, activities and benefits women and men have access to and control over; daily workloads of women and men; and practical and strategic needs, interests and priorities of women and men.

15. The method of claim 1, wherein the intervention plan comprises a market strategy, a water strategy, a gender strategy, and a partnership strategy.

16. The method of claim 1, wherein the monitoring and evaluating of the plan comprises monitoring poverty, environment, and gender criteria.

17. An expert system to reduce poverty, the expert system comprising code to:
identify market opportunities that can be exploited by smallholders;
develop solutions that the smallholders can use to generate income;
establish supply chains to deliver technologies to the smallholders at affordable prices; and
establish linkages with output markets for the smallholders.

18. The system of claim 17, comprising code to optimize a recommendation based on Smallholder Poverty Alleviation, Wealth Creation, Market Sustainability, Project Cost Effectiveness, Model Validation, Gender/Sociocultural Impact, and Environmental Impact.

19. The system of claim 17, comprising code to establish supply chains for micro-irrigation and agricultural inputs, together with technical support, quality control, and training of dealers and sub-dealers to provide effective services to farmers.

20. The system of claim 18, comprising code to perform gender analysis including a cultural and societal study.

21. The system of claim 17, wherein the intervention plan comprises a market strategy, a water strategy, a gender strategy, and a partnership strategy.
